(19) United States
(12) Patent Application Publication
(10) Pub. No.: US 2003/0212538 A1
(43) Pub. Date: Nov. 13, 2003

(54) Method for full-chip vectorless dynamic IR and timing impact analysis in IC designs

(76) Inventors: Shen Lin, Foster City (CA); Andrew Yang, Cupertino (CA); Norman Chang, Fremont (CA)

Correspondence Address: Emil Chang, 874 Jasmine Drive, Sunnyvale, CA, 94086, US

(21) Appl. No.: 10/402,744

(22) Filed: Mar. 28, 2003

Related U.S. Application Data
(60) Provisional application No. 60/380,360, filed on May 13, 2002.

(51) Int. Cl. G06F 17/50

(52) U.S. Cl. 703/14

(57) ABSTRACT

A method for efficient integrated circuit (“IC”) dynamic IR-drop analysis algorithm is disclosed. In one aspect, this method eliminates the need for peak-power input stimulus vectors or Verilog's value change dump (“VCD”). Rather than performing transient simulation over a long set of input vectors to determine the worst dynamic IR-drop, the disclosed method statistically determines the switching direction and the timing for each instance based on its block or module switching scenario. Full-chip transient simulation, including the RLC extracted from the power-ground network, is then performed accordingly over a few clock cycles. This approach makes feasible full-chip dynamic IR verification with the consideration of power-ground inductance and capacitance.

### PRIORITY CLAIM

This application claims priority to a provisional application entitled “Method for Full-Chip Vectorless Dynamic IR-drop Analysis in IC Designs” filed on May 13, 2002, having an Application No. 60/380,360.

### FIELD OF INVENTION

The present invention generally relates to methods for circuit analysis in integrated circuit designs, and, in particular, dynamic IR analysis in integrated circuit designs.

### BACKGROUND

As the development of integrated circuits (“IC”) chip advances, a number of IC design parameters are changed as well. These parameters include (1) the reduction in the supply voltage, (2) the increase in operating frequency, and (3) the reduction in feature size. Correspondingly, power supply fluctuation caused by IR-drop, Ldi/dt, or LC resonance can result in a significant impact to the timing and functionality of the IC. In general, a 10% fluctuation may translate to more than 10% timing uncertainty such that verifying the power supply integrity becomes a tape-out requirement in advance IC designs in order to ensure that the IC will function as designed.

If the chip's operating frequency is not high, static-IR drop verification may be adequate and its approach has been well studied and developed. The average supply current to each instance, including its loading current, short-circuit current, and leakage current, over several cycles is used to determine the full chip IR drop. Because the intrinsic decoupling capacitance existing in the chip between power and ground networks may provide enough current-spike filtering, the power and ground voltages stay within a small range around the values determined from the average current. However, when operating frequency becomes higher or a group of nearby high-power cells switch simultaneously, the charge in the capacitors may be exhausted, causing severe power supply fluctuations. In this case, within-cycle transient analysis, including the consideration of power-ground RLC and intrinsic and inserted decaps, is needed to determine the peak noise on the power-ground network. This analysis is defined as the dynamic-IR analysis.

The most difficult challenge in dynamic-IR analysis is in determining each cell's switching condition in the peak-drop situation. That includes the determinations of which cells will switch, how they will switch (0→1 or 1→0), and when they will switch within that cycle or a couple of cycles. The states of un-switched cells may affect the amount of intrinsic decoupling and hence, also need to be determined. In prior art methods, exhaustive transistor-level or gate-level simulation approach was used. The input stimulus for the simulation is given either by designers (often from RTL function verification vectors, likely not peak-power vectors) or from some intelligent random number generators, e.g. Genetic algorithm.

However, there are fundamental problems with the prior art simulation approaches. First, a prohibitively long set of input vectors is needed to explore every possible corner in a complicated design, especially in a state machine with many states. Furthermore, the worst case may depend on a sequence of inputs, which makes the approach even more infeasible. Second, the worst dynamic-IP drop is influenced by the design of the power-ground networks. It is difficult for a gate-level simulator to consider the electrical effects of the networks. However, performing electrical simulation on the long set of vectors is computationally impossible. Thirdly, these approaches lack the confidence measurement. Even after a very long simulation, designers still do not have any idea of how far away the peak current are from the true peak. Fourthly, in the designs adopting built-in-self-test (“BIST”) circuits, the peak current in the normal operation mode may be much less than the peak current in BIST mode. For example, all banks of memory may be turned on simultaneously in BIST mode. However, any die failing BIST has to be thrown away. Therefore, the peak current determined from simulation may be too optimistic.

The Automatic Test Pattern Generation (“ATPG”) approach was also proposed in generating the peak-power input and state vectors. This algorithm searches for the input and state vectors that will incur the largest number of 0→1 switchings in high power cells. However, the fundamental problems with the ATPG approach include, first, the reliance on the assumption that every vector is possible out of the registers, latches, or flip-flops. This means every state is reachable. Quite often the number of reachable state is small and hence the results are too pessimistic. Secondly, similar to the problem of the gate-level simulation approach, it is difficult to consider the design of power-ground networks and electrical effects. Thirdly, this approach ignores the timing-correlation between cells as it only considers the logic satisfiability. Due to timing delays, some cells may not switch simultaneously. Fourthly, similar to the problem with the gate-level simulation approach, its results may be optimistic if BIST is adopted. Lastly, in handling complicated designs, ATPG's run time may be too long because it is an NP-Complete problem in general as is known in the art.

Given the issues with respect to current methods in conducting dynamic-IR analysis, it is therefore desirable to have a method for dynamic-IR analysis that can overcome the problems of the current state of the art.

### SUMMARY OF THE INVENTION

It is therefore an object of the present invention to provide vectorless, statistical methods for conducting dynamic IR analysis in an IC design.

It is another object of the present invention to provide methods for determining cell current profile in conducting dynamic IR analysis in an IC design.

It is yet another object of the present invention to provide methods for determining the switching instances in a given clock cycle in conducting dynamic IR analysis in an IC design.

It is still another object of the present invention to provide vectorless, statistical methods for conducting timing impact analysis in conducting dynamic IR analysis in an IC design.

Briefly, a statistical vectorless dynamic-IR analysis method is disclosed. Here, a number of steps are performed prior to conducting transient simulation. First, for each cell of the IC design, the cell current profile is determined and stored. In the next steps, the instances that will switch during simulation are determined and the timings of such switching instances within a timing window of a clock cycle are determined as well. In conducting the transient simulation (using a spice-like tool), a number of input parameters are used, including the RLC model for each cell, the determined switching instances, the determined switching timing, and the cell current profile. From the transient simulation, a resulting scenario is generated depicting dynamic IR-drop information at the cell level. This simulation process may be conducted a number of times as desired, each time using a different random number generator to generate a different resulting scenario. One (or more, or combinations) of the resulting scenarios may be selected for determining impact to timing and decoupling capacitor insertion.

An object of the present invention is to provide vectorless, statistical methods for conducting dynamic IR analysis in an IC design.

Another object of the present invention is to provide a method for determining cell current profile in conducting dynamic IR analysis in an IC design.

Yet another object of the present invention is to provide a method for determining the switching instances in a given clock cycle in conducting dynamic IR analysis in an IC design.

Still another object of the present invention is to provide a method for conducting timing impact analysis in conducting dynamic IR analysis in an IC design.

### IN THE DRAWINGS

FIG. 1 illustrates a system view of the presently preferred embodiment of the present invention;

FIG. 2 illustrates the method steps of the preferred embodiment of the present invention;

FIG. 3 illustrates the method steps into determining whether an instance would switch during simulation;

FIG. 4a illustrates a power-ground RLC model for conducting transient simulation for dynamic IR analysis;

FIG. 4b illustrates the circuit components composing Cdecoupling of FIG. 4a;

FIG. 5 illustrates switching of an instance in a given timing window;

FIGS. 6a-6c illustrate the sample waveforms that may be used in determining how switching may occur in a given cycle;

FIG. 7a illustrates a circuit modeling of a cell;

FIG. 7b illustrates a sample resulting waveforms from the circuit of the FIG. 7a;

FIG. 8a illustrates a sample set in a two dimensional space having a number of instances;

FIG. 8b illustrates a reference set representative of the sample set with predefined spacing between the instances;

FIG. 9a illustrates the method steps in generating the referenced set from the sample set;

FIGS. 9b-9c illustrate the indexing of the instances in the sample set and in the reference set respectively;

FIG. 9d illustrates the mapping information from the sample set to the reference set;

FIGS. 10a-10c illustrate sample current profile waveforms; and

FIG. 11 illustrates the method steps for dynamic modification of instance timing information.

### DETAIL DESCRIPTION OF THE PREFERRED EMBODIMENTS

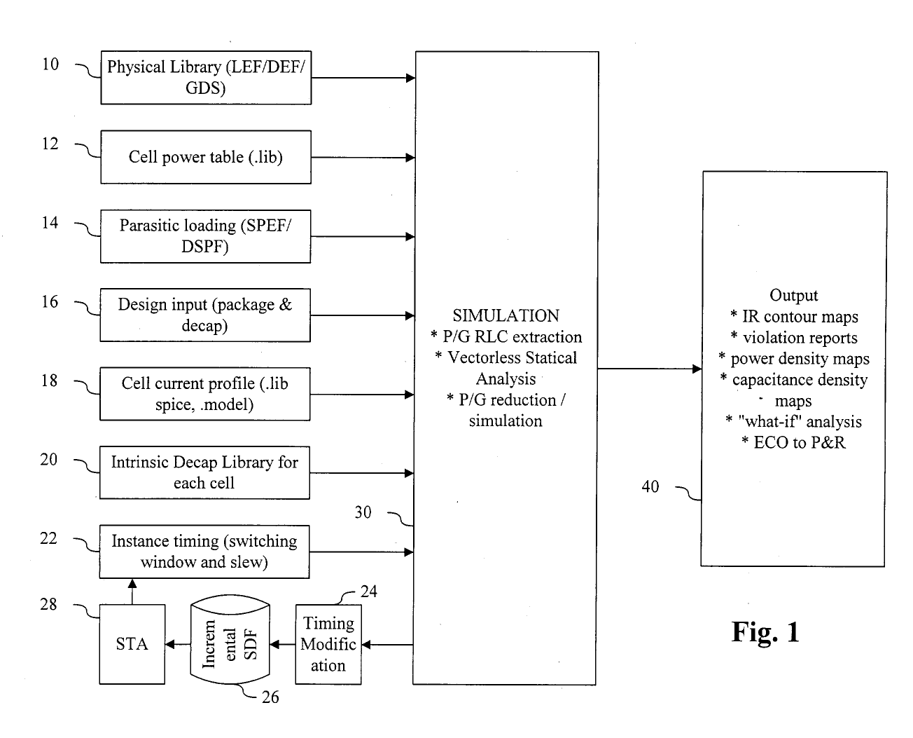

Referring to FIG. 1, in a system view of the presently preferred embodiment of the present invention, a full-chip vectorless dynamic analysis process, is disclosed. Here, a number of inputs 10-22 are provided to a presently preferred embodiment of the present invention 30, which generates a number of output results 40.

The inputs to the system includes physical libraries (including the design to be tested) 10, which can be in a variety of formats such as LEF, DEF, or GDS formats and are available from a variety of sources, cell power table 12 generally available from foundry and other sources, parasitic loading information 14 generally available from RC extraction tools and other sources, design input information including package and decap information 16, cell current profile information 18, intrinsic decap library information for each cell 20 generally from foundry or other sources, and instance timing information 22 from static timing analysis or other sources.

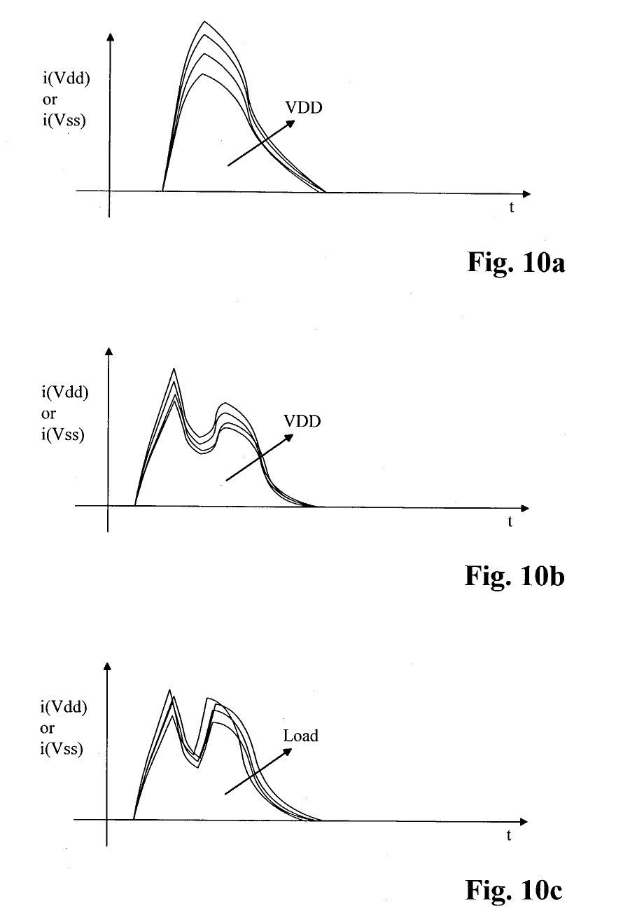

The cell current profile information 18, examples of which are illustrated in FIGS. 10a-10c, contains i(t) (current as a function of time) information for various conditions, including but not limited to, for example, current information over time with respect to rising edges and Vdd, FIG. 10a, current information over time with respect to falling edges and Vdd, FIG. 10b, and current information over time with respect to falling edges and load, FIG. 10c. Other information such as slew rate and input node information are also available. Novel methods for generating the current profile information is described later in this disclosure.

Referring back to FIG. 1, the primary output 40 includes a variety of information including IR contour maps, violation reports, power density maps, capacitance density maps, results of conditional analysis, and engineering change order (“ECO”) to place & route (“P&R”) information. The process method 30 also generates additional timing modification information 24 which can be stored in an incremental standard delay format (“SDF”) 26. With the use of static timing analysis (“STA”) tools 28, the timing modification information 24 can be processed to provide updated instance timing information 22. Novel methods for dynamically updating instance timing information is described later in this disclosure.

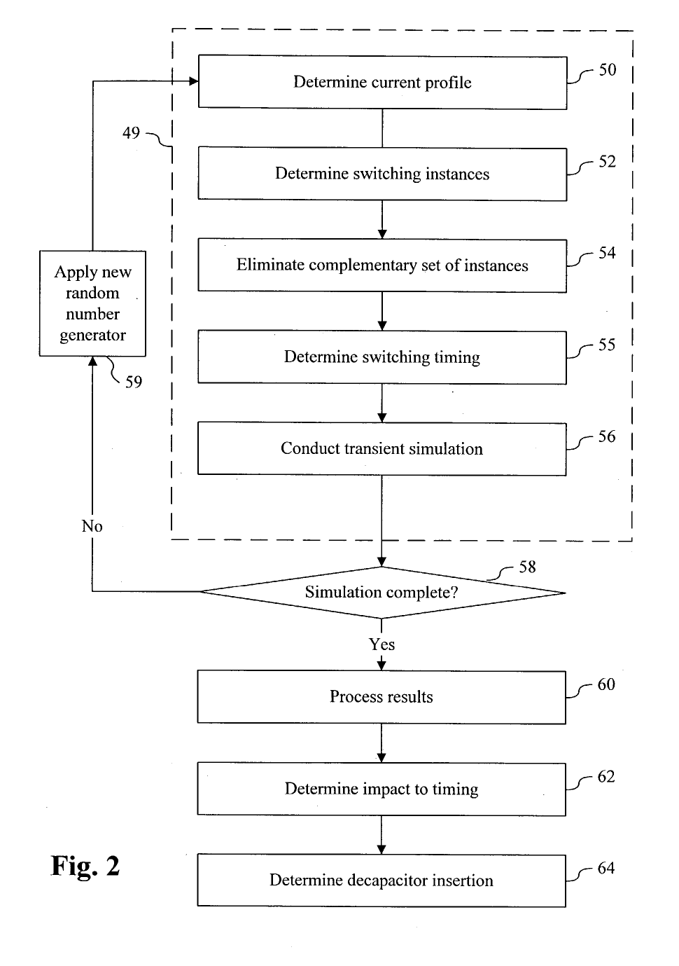

FIG. 2 illustrates the presently preferred method of the present invention (which is FIG. 1, 30). In a first step 50, the instance power of the cell is determined as a function of the parasitic loading information (FIG. 1, 14) and instance timing information (such as input slew rate) (FIG. 1, 22) by one of two methods. In a first method, a simple table-lookup scheme is used where the parasitic loading information and the instance timing information serves as input parameters to index information in the cell power table (FIG. 1, 12), and the information retrieved from the cell power table is used as a part of the total instance power calculation, where total instance power equals internal power plus switching power. Internal power is from the cell power table and switching power is calculated from the well known formula ½cv²fα, where c is capacitance, v is voltage, f is frequency and α is toggle rate. This is a simple table lookup scheme where the cell power table is generally available from foundry or other sources. Once total instance power is known, it can be used to determine the current profile. In a second method, the parasitic loading information and the instance input slew rate information is used to select a current profile from the cell current profile library (FIG. 1, 18). The cell current profile library is developed from novel methods described later in this disclosure.

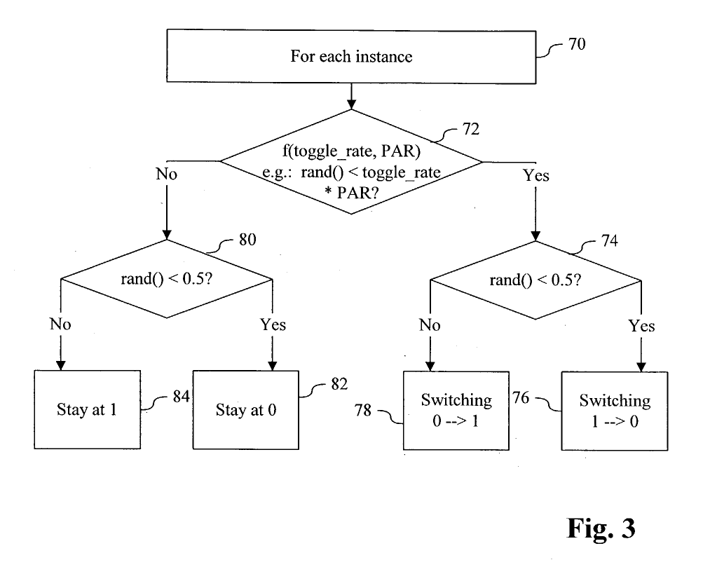

In the next step 52, because not all instance of the design will switch during a given clock cycle, the instances that will switch are determined. Referring to FIG. 3, in determining whether an instance would switch in a given clock cycle, a random number generator is used to generate a random number between 0 and 1. Also, two other parameters, toggle rate and PAR, are used, where toggle rate is a user-provided value which indicates the probability of an instance switching.

PAR is defined as peak power over average power for a circuit block, where peak power and average power may be obtained from the power calculation of a user provided vector-change-dump (“VCD”) stream. The equation for PAR is defined as:

$$PAR = \frac{Peak\_power}{Average\_power} ,$$

where Peak_power is defined as MAX (ap1, ap2, ap3, . . . ). Ap# is defined as the average power over a few cycles (around 1, 2 or 3 cycles). Both ap# and Average_power is defined by the following formula:

$${\int }_{t}^{t + nT} \frac{V * i ( t ) ⅆ t}{nT} ,$$

where n is the number of clock cycles, V is voltage, i(t) is the current at time t, and T is a clock cycle. For ap#, n is a small number (around 1, 2, or 3), and, for Average_Power, n is the number representing the entire time period. Thus, each ap# represents a sliding window of a few cycles over the entire time period and max(ap1, ap2, ap3, . . . ) is the sliding window having the maximum average power over a small number of cycles. As can be seen from the equation, peak power is used as a constraint for the dynamic IR analysis over the clock cycle. PAR can also be calculated from the user provided vector-change-dump stream where the worst power cycle is divided by the average power derived from the full VCD stream.

In determining whether an instance would switch or not, in one method, referring to FIG. 3, this determination can be made as a function of toggle_rate and PAR. In one example, the formula rand ( )<toggle_rate*PAR is used. For example, if the random number is less than toggle_rate*PAR 72 and if the random number is greater than 0.5 74, the given instance is determined to switch from 1 to 0 76. If the random number is less than toggle_rate*PAR 72 but less than 0.5 74, the given instance is determined to switch from 0 to 1 78. If the random number is not less than toggle_rate*PAR 72 and is not less than 0.5 80, the given instance is determined to stay at 0 82. Otherwise, if the random number is less than toggle rate*PAR 72 but is less than 0.5 80, the given instance is determined to stay at 1 84. This process is applied to every instance in the design in determining whether the given instance would switch or not. Referring back to FIG. 2, now that all the instances of the design has been evaluated for switching, logic conflict resolution through logic propagation is then used to eliminate the complementary set of the instances that would not switch at the same time 54. By applying this step, unnecessary simulation processing time is minimized.

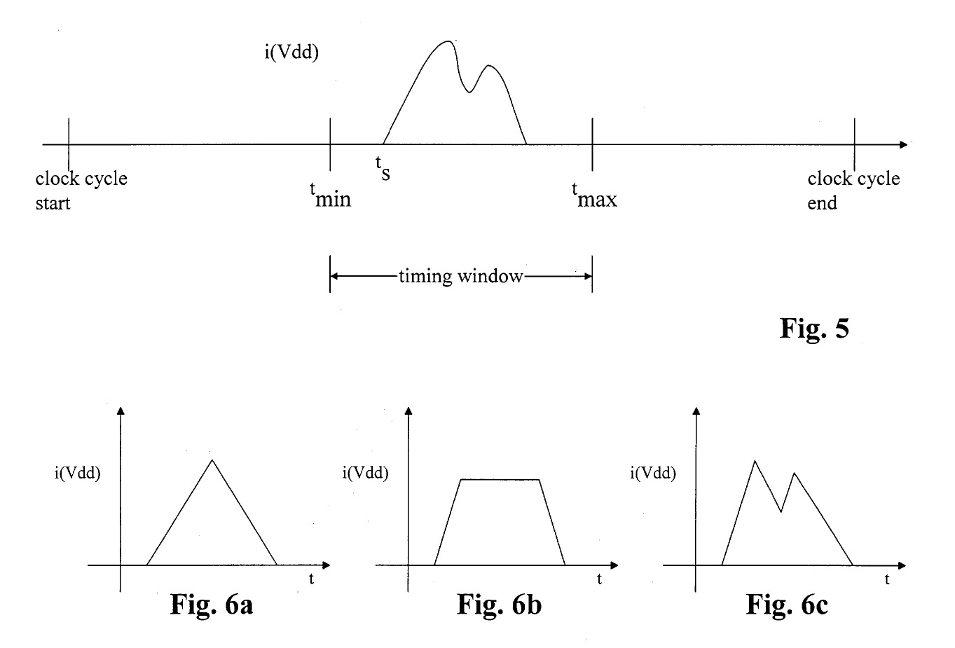

In the next step 55, the switching timing is determined. The goal here is to determine when switching will occur within a timing window of a clock cycle (“in-window switching timing information”). Referring to FIG. 5, a current profile within a timing window of a clock cycle is illustrated. The clock cycle is as illustrated in FIG. 5 and the timing window is bounded by tₘᵢₙ and tₘₐₓ and may occur any time within the clock cycle. It is desirable to have tₘᵢₙ and tₘₐₓ as narrow as possible and the timing window is typically generated by a STA tool. The instance may switch any time during the timing window and the start of which is as indicated at time tₛ. In the preferred embodiment of the present invention, tₛ is calculated by using the following equation:

tₛ=tₘᵢₙ+rand( )*(tₘₐₓ−tₘᵢₙ)

where rand( ) is a generated random number. In this manner, the timing of the switching within a clock cycle is determined.

In the next step 56, now knowing the switching instances, transient simulation is performed over the entire design by using a spice-like tool. In conducting the simulation, four input parameters are known and used: (1) whether an instance would switch or not, (2) the power-ground RLC network model representing the instance, (3) when the instance switches in the given clock cycle, and (4) how the instance switches. The first parameter, whether an instance switches or not is known from the last step (FIG. 2, 52).

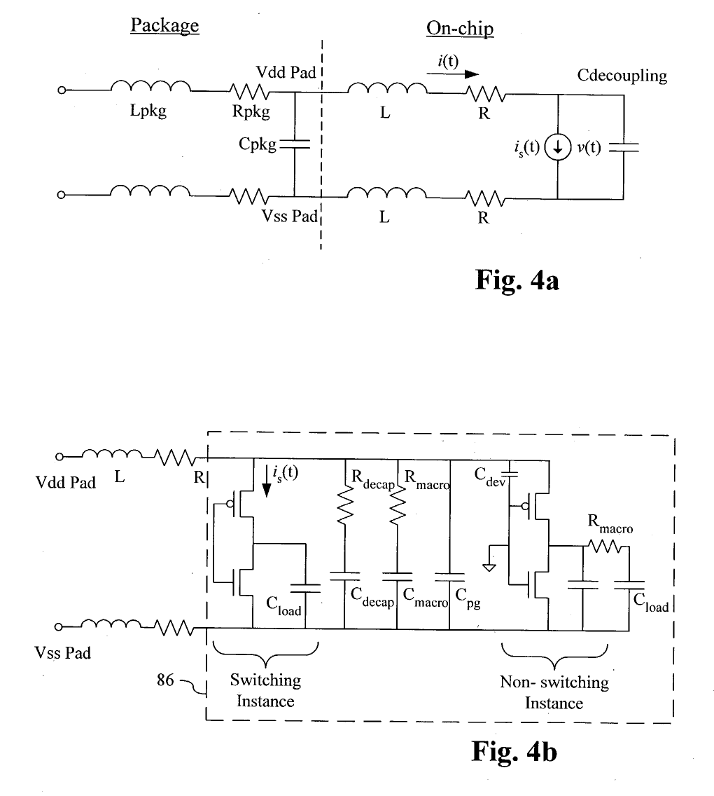

With respect to the second parameter, the power-ground RLC network models are from the physical library (FIG. 1, 10) or can be extracted by using a variety of tools. FIG. 4a illustrates a circuit model for conducting transient simulation for dynamic IR analysis. On the left side of the dash line (delineating package and on-chip boundary), package LRC information at the Vdd pad and the Vss pad is illustrated. On the right side of the dash line the on-chip LRC model is illustrated where iₛ(t) represents the dynamic switching current and Cdecoupling indicates the decoupling capacitance. FIG. 4b further illustrates the circuit components 86 composing Cdecoupling of FIG. 4a. Here, Cdecap represents the capacitance of the intentional decap cells, Cmacro represents the capacitance of macro blocks (such as memory cells), Cdev represents intrinsic decoupling capacitance of the cell, Cload represents decoupling capacitance contributed from cell loading, and Cpg represents parasitic decoupling capacitance between power and ground wires. These different types of capacitance can be extracted out for simulation purposes.

With respect to the third input parameter, the in-window switching timing information, it is as described in a previous step, FIG. 2, 55.

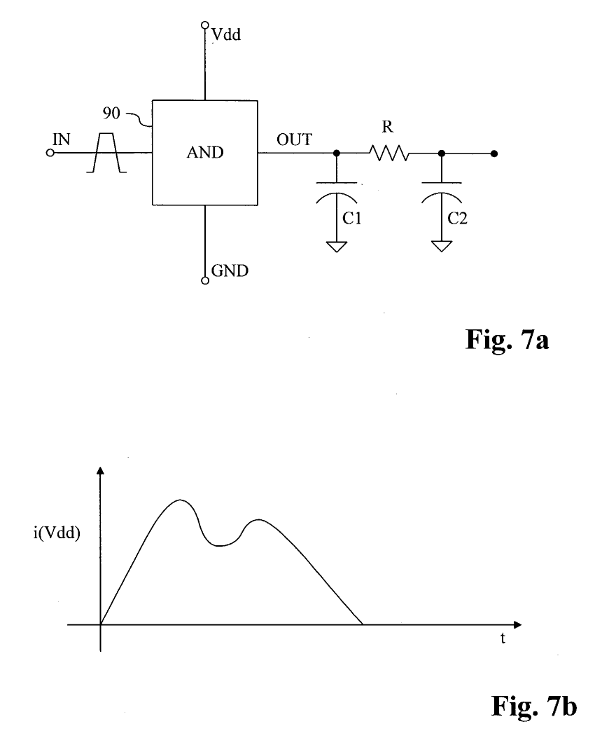

With respect to the fourth input parameter, in determining how an instance switches (“current switching profile”), the selected current profile from the cell current profile library (from FIG. 1, 18) may be used. Other user-specified waveforms can also be used, such as a triangular waveform an example of which is illustrated by FIG. 6a, a trapezoid waveform an example of which is illustrated by FIG. 6b, a bimodal waveform an example of which is illustrated by FIG. 6c, or any variation thereof. Other types of waveforms may be used as well.

Given these input parameters, transient simulation can be performed by using spice-like tools and the impact to timing can be determined 60. The transient simulation can be run a number of time as desired 58, each time using a different random number generator 59 to generate random numbers for use in the calculations 49 leading to the transient simulation and each time generating a resulting switching scenario. After simulation is complete, a number of switching scenarios would have been generated and a switching scenario is selected from all of the switching scenarios 60. In the preferred embodiment, the selected switching scenario is chosen based on the median value of the dynamic IR drop values of all of the switching scenarios. Other methods for choosing a scenario or combinations of scenarios can be used as well. For example, in choosing one scenario, any other statistical functions may be used as well, functions such as minimum, maximum, average, mode, etc. Combinations of scenarios can be selected as well as desired.

Once a switching scenario is selected, the impact to timing can be determined 62. Note that because simulation is conducted at the cell level, timing information is thereby generated at the cell level. Therefore, from the simulation step (FIG. 2, 56), voltage information (Vdd and Vss) for each instance are generated and provided in piece-wise linear waveform format or pwl(v). More detailed disclosure with respect to timing analysis is described later in this disclosure.

In the next step 64, now having simulation completed, the IR drop with respect to each instance is known. Given a user-defined threshold level as to IR drop, instances having an IR-drop exceeding the given threshold level can be flagged as hot spots. From this information, an IR contour map can be developed and displayed to show the hot spots. Violation reports can be generated as well. Since power information is known as well, power density maps can be developed as well. The same is true for capacitance information for generating capacitance density maps.

Furthermore, in eliminating hot spots, capacitors having certain calculated capacitance can be strategically inserted at the nodes around the hot spots (or within a block of hot spots) in order to minimize IR-drop. After capacitor insertion is done, the entire simulation process can again be performed to analyze changes to the hot spots. The cycle can be repeated a number of times until the hot spots are minimized.

It shall be apparent to one skilled in the art that although FIG. 2 is depicted in specific steps, the specific order of the steps can be varied depending on the dependency of a step to another step and the specific steps actually used.

Design-Dependent Vdd Current Waveform Generation

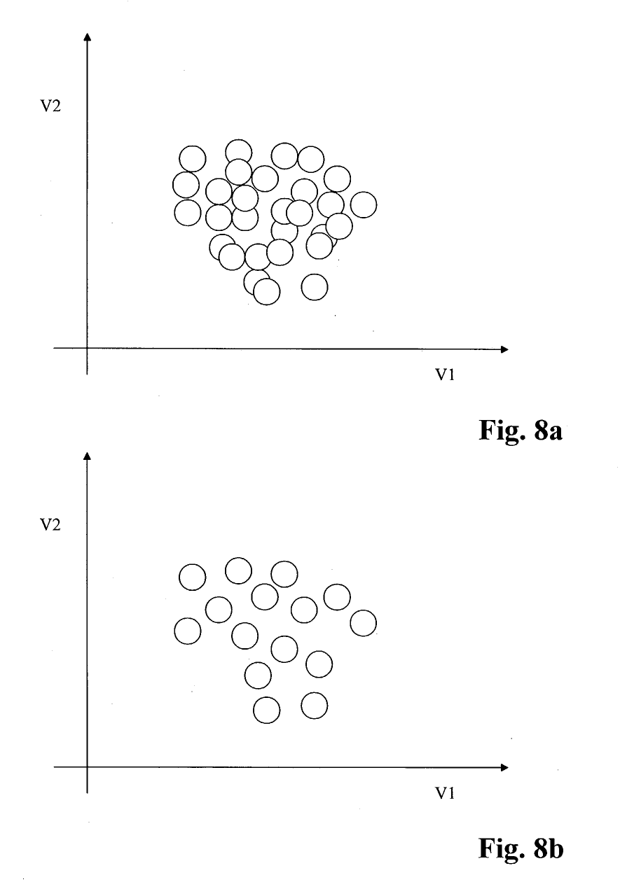

Since a cell may be instantiated thousands of times during simulation, each time using different combinations of variables defining the instance, instantiation of each cell becomes an overwhelming time-consuming task in performing simulations. In order to manage this task on an efficient and effective basis, two steps are taken. In a first step, each cell is modeled and instantiated to generate a sampling set. More specifically, referring to FIG. 7a, each cell is modeled to drive a distributed RC network with, for example, an AND gate 90, with variables including the Vdd, rise slew rate, the fall slew rate, C1, R, and C2. In instantiating a cell with the given set of variables, a waveform is generated in the process, an example of which is illustrated by FIG. 7b. Given the fixed Vdd sampling variable and five variables (rise slew rate, fall slew rate, C1, R, and C2), since a cell may be instantiated thousands of times, each time generating an instance from the different combinations of the five variables, a sample set representing the cell may have thousands of instance instantiations.

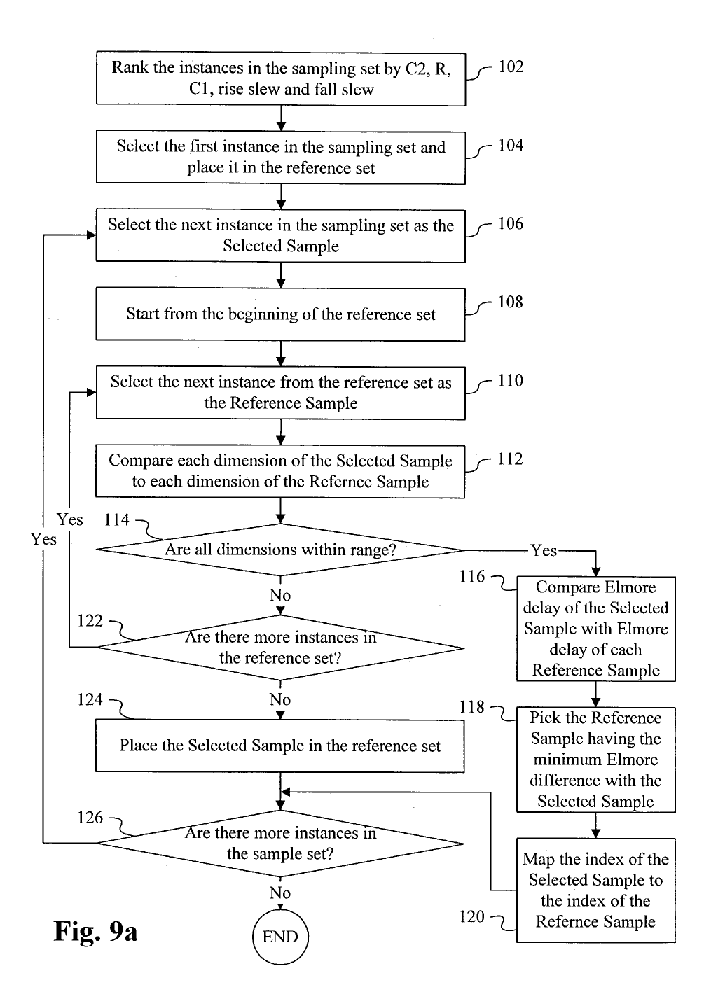

In a second step, in order to minimize the number of instances yet still have a representative sample set, a reference set, which is a subset of the sample set, is derived from the sample set and yet representative of the sample set. To visually illustrate this idea, FIG. 8a illustrates a portion of a sample set in two dimensional space. Note that the instances in the sample set may be spatially near or overlapping each other. After the application of the method of this invention, referring to FIG. 8b, a reference set representative of the sample set is created where there is predefined spacing between the instances. The instances in the reference set still effectively represent the sample set. The reference set is also referred to as cell current profile library (FIG. 1, 18) which is used in the above described method.

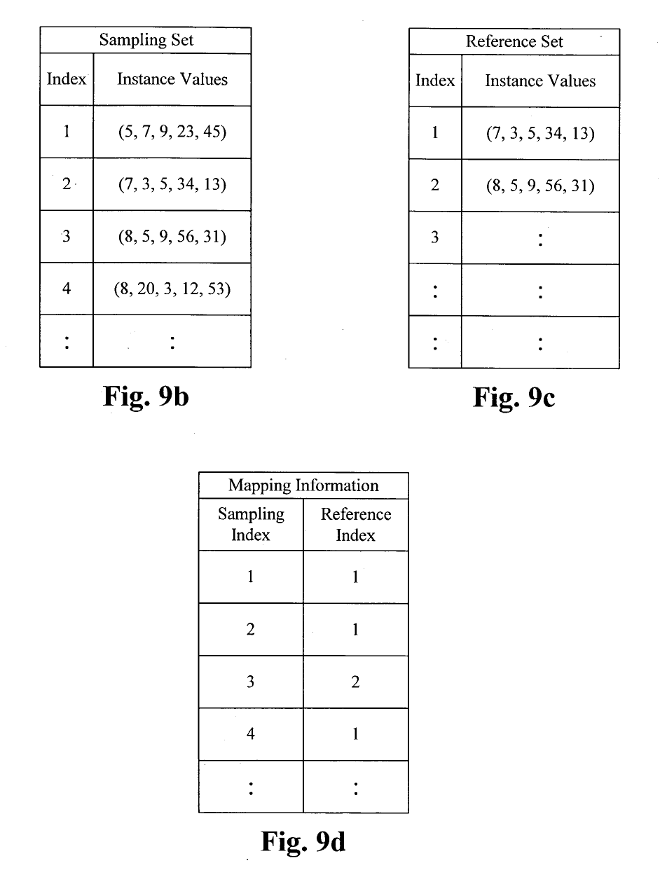

Referring to FIG. 9a, a presently preferred method for generating the reference set is presented. Here, in first step 102, all of the instances in the sampling set are ranked. Although there may be many ways to rank the sampling set, in the preferred the embodiment of the present intention, the sampling set is ranked by C2, R, C1, rise slew, and fall slew in an ascending manner. In the next step 104, the first instance of the ranked sampling set is selected and placed in the reference set. Then 106, the next instance in the ranked sampling set is selected as the Selected Sample. Now the Selected Sample is compared against each instance in the reference set starting from the top of the reference set 108. In the next step 110, the next instance in the reference set is selected as the Reference Sample to be compared to the Selected Sample. In the comparison step 112, each dimension of the Selected Sample is compared to each dimension of the Reference Sample. For example, C1 of the Reference Sample is compared to C1 of the Selected Sample and R of the Reference Sample is compared R of the Selected Sample and so on. If each dimension of the Selected Sample is within a predefined range of the Reference Sample, it can be said that the Selected Sample is already represented in the reference set by the Reference Sample. The predefined range defined the spacing between the samples for representation purposes and can be user specified. For example, for the predefined range can be set to a percentage of the value of the corresponding dimension of the Reference Sample or it can be set to the value of the dimension plus the minimum value of the selected dimension. In the preferred embodiment, for example, the predefined range is set to +/−10 percent.

If all of the dimensions of the Selected Sample all within range 114, the Elmore delay of the Selected Sample is calculated and compared with the Elmore delay of each Reference Sample in the reference set 116. The Reference Sample having the smallest Elmore difference with the Selected Sample is chosen to represent the Selected Sample 118. The equation of the Elmore delay is:

Elmore_{—}delay=slew+1000*(C1+C2)+(R*C2),

where slew is in picosecond, 1000 is the typical driving resistance, R in ohm, and C1 and C2 in pF.

In order to keep track of the mapping between the Selected Sample and the Reference Sample, a mapping table is created. Referring to FIG. 9b, the ranked sampling set is illustrated in a table format where each instance in the sample set is indexed. Similarly, referring to FIG. 9c, each instance in the reference set is indexed as well. With these two sets indexed, a mapping table can easily be created where an index of the sampling set is mapped to an index of the reference set. Referring to FIG. 9d, as an illustration, the first, second, and fourth instances in the sample set is mapped to the first instance in the reference set and the third instance in the sample set is mapped to the second instance in the reference set. Note that the numbers shown in the tables are for illustration purposes only and are not valid numbers.

If not all of the dimensions are within range 114, the Selected Sample is compared to the next instance in the reference set 122. If there is any remaining Reference Sample 122, the next instance from the reference set is selected as the Reference Sample 110. If there are no more instances in the reference set 122, the Selected Sample is placed in the reference set and becomes a Reference Sample 124. In the next step 126, the cycle is repeated if there are more instances in the sample set. Otherwise, the process is complete, and Vdd current waveform (or cell current profile) are generated and stored in the cell current profile library. To illustrate some of these current profiles, FIG. 10a illustrates current information over time with respect to rising edges and Vdd, FIG. 10b illustrates current information over time with respect to falling edges and Vdd, and FIG. 10c illustrates current information over time with respect to falling edges and load.

Novel Method for Dynamic Modification of Instance Timing Information

In the prior art, timing analysis is a static timing analysis with fixed Vdd voltage and tools for conducting dynamic timing analysis with real Vdd waveforms are not available for the simple reason that dynamic analysis are not done at the cell level. Now, with the methods of the present invention, dynamic timing analysis at the cell level becomes a possibility and novel methods for dynamic timing analysis can therefore be developed.

Given the present invention as described above, timing information with respect to each instance is generated in the process. Now having this information, it would be desirable to develop a process for dynamically updating timing information for the simulation process.

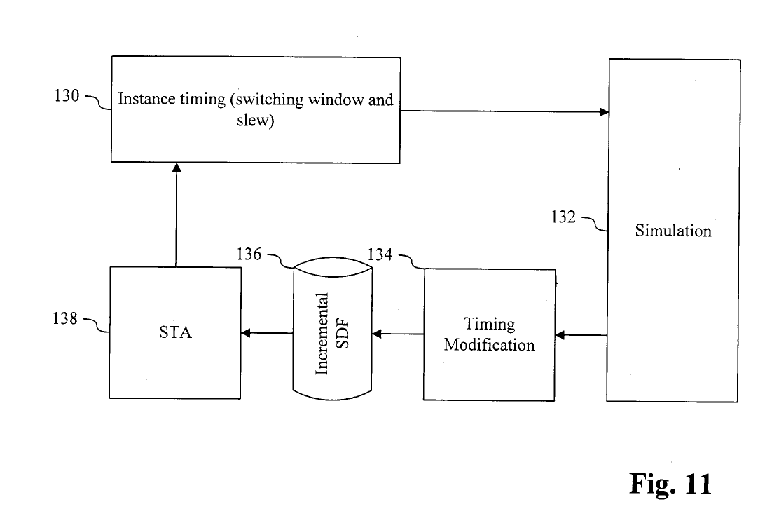

Here, novel methods for dynamic modification of instance timing information are disclosed. Referring to FIG. 11, a feedback loop for updating timing information is illustrated. Instance timing information 130 is provided to the simulation process 132. In conducting the simulation, pwl(v) for each instance is generated. Now having the pwl(v) for each instance, several methods 134 may be used to create an automatic updating process. In a first method, in the timing modification step 134, the pwl(v) information is fed to a spice-like program to generate the resulting change to timing information with respect to the given instance. The resulting change is provided in incremental SDF format and stored 136. The information is then processed by a STA tool 138 to update the instance timing information 130.

In a second method, instead of using a spice tool, a modulation method is used to scale the delay. The pwl(v) information from the simulation process 132 is modulated by using the function avg(pwl(v)) over the switch window of the instance 134. Similarly, the resulting change is provided in incremental SDF format and stored 136 and processed by a STA tool 138 to update the instance timing information 130. In a third method, instead of using the avg(pwl(v)) function, the min(pwl(v)) function is used in the timing modification step 134. Note that it shall be understood by one skilled in the art that a number of different statistical or mathematic functions may be used in calculating the timing modification.

While the present invention has been described with reference to certain preferred embodiments, it is to be understood that the present invention is not to be limited to such specific embodiments. Rather, it is the inventor's contention that the invention be understood and construed in its broadest meaning as reflected by the following claims. Thus, these claims are to be understood as incorporating and not only the preferred embodiment described herein but all those other and further alterations and modifications as would be apparent to those of ordinary skilled in the art.

We claim:

1. A method for analyzing an integrated circuit design, comprising the steps of:
determining instance current profile for each cell of said integrated circuit design;
determining switching instances of said integrated circuit design; and
conducting transient simulation of said integrated circuit design.

2. A method as recited in claim 1, wherein in said determining instance current profile step, said instance current profile is determined as a function of instance timing information.

3. A method as recited in claim 1, wherein in said determining instance current profile step, said instance current profile is determined as a function of parasitic load information.

4. A method as recited in claim 2, wherein in said determining instance current profile step, said instance current profile is determined as a function of parasitic load information.

5. A method as recited in claim 1, wherein in said determining switching instances step, said switching instances is determined as a function of toggle rate.

6. A method as recited in claim 1, wherein in said determining switching instances step, said switching instances is determined as a function of PAR.

7. A method as recited in claim 1, wherein in said determining switching instances step, said switching instances is determined as a function of a random number.

8. A method as recited in claim 5, wherein in said determining switching instances step, said switching instances is determined as a function of PAR.

9. A method as recited in claim 5, wherein in said determining switching instances step, said switching instances is determined as a function of a random number.

10. A method as recited in claim 8, wherein in said determining switching instances step, said switching instances is determined as a function of a random number.

11. A method as recited in claim 1, wherein after said determining switching instances step and before said conducting transient simulation step, an additional step of determining switching timing is performed.

12. A method as recited in claim 11, wherein in said determining switching timing step, said step is determined as a function of a random number.

13. A method as recited in claim 1, wherein in said conducting transient simulation step, said simulation is conducted as a function of extracted RLC network.

14. A method as recited in claim 1, wherein in said conducting transient simulation step, said simulation is conducted as a function of said determined switching instances.

15. A method as recited in claim 1, wherein in said conducting transient simulation step, said simulation is conducted as a function of switching waveform.

16. A method as recited in claim 1, wherein in said conducting transient simulation step, said simulation is conducted as a function of in-window switching timing information.

17. A method as recited in claim 13, wherein in said conducting transient simulation step, said simulation is conducted as a function of said determined switching instances.

18. A method as recited in claim 13, wherein in said conducting transient simulation step, said simulation is conducted as a function of in-window switching timing information.

19. A method as recited in claim 13, wherein in said conducting transient simulation step, said simulation is conducted as a function of switching waveform.

20. A method as recited in claim 17, wherein in said conducting transient simulation step, said simulation is conducted as a function of in-window switching timing information.

21. A method as recited in claim 17, wherein in said conducting transient simulation step, said simulation is conducted as a function of switching waveform.

22. A method as recited in claim 20, wherein in said conducting transient simulation step, said simulation is conducted as a function of switching waveform.

23. A method for analyzing an integrated circuit design, comprising the steps of:
determining instance current profile for each cell of said integrated circuit design;
determining switching instances of said integrated circuit design;
determining switching timing of said switching instances; and
conducting transient simulation of said integrated circuit design.

24. A method as recited in claim 23, further including a looping step, after said conducting step, for performing all of said steps a pre-defined number of times, each time generating a resulting scenario.

25. A method as recited in claim 24, further including a step, after said looping step, for selecting a resulting scenario from said resulting scenarios.

26. A method as recited in claim 25, further including a step, after said selecting a resulting scenario step, for determining impact to timing.

27. A method as recited in claim 25, further including a step, after said selecting a resulting scenario step, for determining decapacitor insertion.
